(19) United States
(12) Patent Application Publication
(10) Pub. No.: US 2018/0075248 A1
(43) Pub. Date: Mar. 15, 2018

(54) MANAGING PRIVILEGES TO ACCESS DATA IN A DATABASE

(71) Applicant: THE DUN & BRADSTREET CORPORATION, Short Hills, NJ (US)

(72) Inventors: Vimal VEL, Morris Plains, NJ (US); Illya D'ADDEZIO, Short Hills, NJ (US); Elizabeth Avery GOMEZ, Whippany, NJ (US); Thomas CARLOCK, Montvale, NJ (US)

(21) Appl. No.: 15/610,678

(22) Filed: Jun. 1, 2017

Related U.S. Application Data
(60) Provisional application No. 62/385,692, filed on Sep. 9, 2016.

(51) Int. Cl. G06F 21/62; G06F 21/44; G06F 17/30

(52) U.S. Cl. CPC G06F 21/6218; G06F 17/30569; G06F 21/44

(57) ABSTRACT

There is provided a method that includes (a) transmitting to a first user device, a license to access data in a database, (b) receiving the license from a second user device, (c) customizing the data, thus yielding customized data; and (d) transmitting the customized data to the second user device. There is also provided a system that employs the method.

### BACKGROUND OF THE DISCLOSURE

### 1. Field of the Disclosure

The present disclosure relates to a data distribution system, and more specifically, managing privileges to access data in a database in a data distribution system.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

In a data storage and distribution system, there may exist a situation where a user wishes to obtain data from a database that houses data to which the user does not have access privileges. For example, the user may have privileges to access some, but not all, of the data on the database. Also, data from disparate systems may be incomplete, inaccurate, or yield a result set that is too large for consumption or dissemination. Some methods of distribution improve completeness and accuracy of data transmission yet result in very large data transfers.

For example, assume that a user, by way of a user device, requests data from a customer relationship management (CRM) system. The CRM system will send the requested data over a network to the user device. The terms of use of the data within the CRM system are governed by a licensing agreement between a disclosing party, i.e., an owner of the data, and a consuming party, i.e., a recipient of the data. In some situations, the user needs, and is allowed, to transfer the data from a first device of the consuming party to a second device of the same consuming party or a different party. Often, in these cases, the data required by the second device is different from that required by the first device, and the data is specific to use-cases within the devices. As an example, the CRM system might transmit data to an enterprise resource planning (ERP) system, but the data required by the ERP system is different and unique from that required by the CRM system. A possible solution to this situation uses a master data management (MDM) system in which CRM data is sourced by the CRM system, and ERP data is sourced by the ERP system, and these data sets are reconciled as part of an MDM process with the MDM system.

In a subset of this situation, an end-user system is further restricted in that a data packet must be licensed for use within each system, e.g., licensing terms will define whether the CRM data can be used in another system. Data packet licensing is designed to prevent the transfer of information to unlicensed users (devices), such as an MDM or ERP system from the same user (company).

Managing movement and access of data in various systems based on distinct licensing terms creates technical challenges. In the CRM and ERP systems example mentioned above, if the CRM requires dataset#1 which is 100 elements of information and the ERP requires dataset#2 which requires a different 150 elements, a current model of access and movement requires the data to all (250 elements) to be accessed by the CRM and the ERP. When each of these elements of data are distinct and of high value, they are often licensed for use in a named system, e.g., CRM, and there are incremental licensing costs associated with consumption in additional systems. To solve for this challenge, companies often try to check licensing requirements and partition the data for each system from a full packet of data and then drop the unlicensed part to remain compliant with the licensing terms. A typical way to overcome a data movement challenge is to move all the data across the multiple systems. However, this creates challenges with licensing models, as described above. A typical way to address varying licensing challenges is to source data from each system based on distinct licensing requirements. However, this approach doesn't solve the data movement challenges.

### SUMMARY OF THE DISCLOSURE

The present document discloses a method that enables licensing, access and movement of distinct types of data across multiple systems and end-users. The method includes (a) transmitting to a first user device, a license to access data in a database, (b) receiving the license from a second user device, (c) customizing the data, thus yielding customized data; and (d) transmitting the customized data to the second user device.

The customizing is performed in accordance with the license, and includes modifying the data.

If the license is accompanied by a descriptor of an identity of a user of the second user device, the customizing includes configuring the customized data in accordance with the identity of the user.

If the license is accompanied by a descriptor of an identity of the second user device, the customizing includes configuring the customized data in accordance with the identity of the second user device.

If the license is accompanied by a descriptor of a characteristic of the second user device, the customizing includes configuring the customized data in accordance with the characteristic.

If the license is accompanied by a descriptor of an application that is being utilized by the second user device, the customizing includes configuring the customized data in accordance with the application.

There is also provided a system that employs the method.

### BRIEF DESCRIPTION OF THE DRAWINGS

FIG. 1 is a block diagram of a data distribution system.

FIG. 2 is a block diagram that shows some details of a module of the system of FIG. 1, and illustrates several items of information that are exchanged between components in the system of FIG. 1.

FIG. 3 is a flowchart of a method that is performed by a server in the system of FIG. 1.

FIG. 4 is a signal flow diagram of a sequence of communications taking place during a communication session.

A component or a feature that is common to more than one drawing is indicated with the same reference number in each of the drawings.

### DESCRIPTION OF THE DISCLOSURE

A system represents one or more associated devices that may include hardware, e.g., computers, components, e.g., peripherals, and associated software, e.g., applications, with common storage and processors, operating in unison to provide specific functions. Entitlement represents the data access permissions agreed upon in a licensing contract between a consuming party and a data provider system. Authenticating credentials may be established by a consuming party in conjunction with a data custodian or an agent/partner to permit license certificate and data packet requests from end-user systems, or issued by the data custodian or agent/partner. Authentication is an act of determining that an end-user system should be authorized to act on behalf of a specific consuming party. Authorization implies that the system or device has certain entitlements required to perform its role and that it has successfully authenticated to the system or device with which it is communicating.

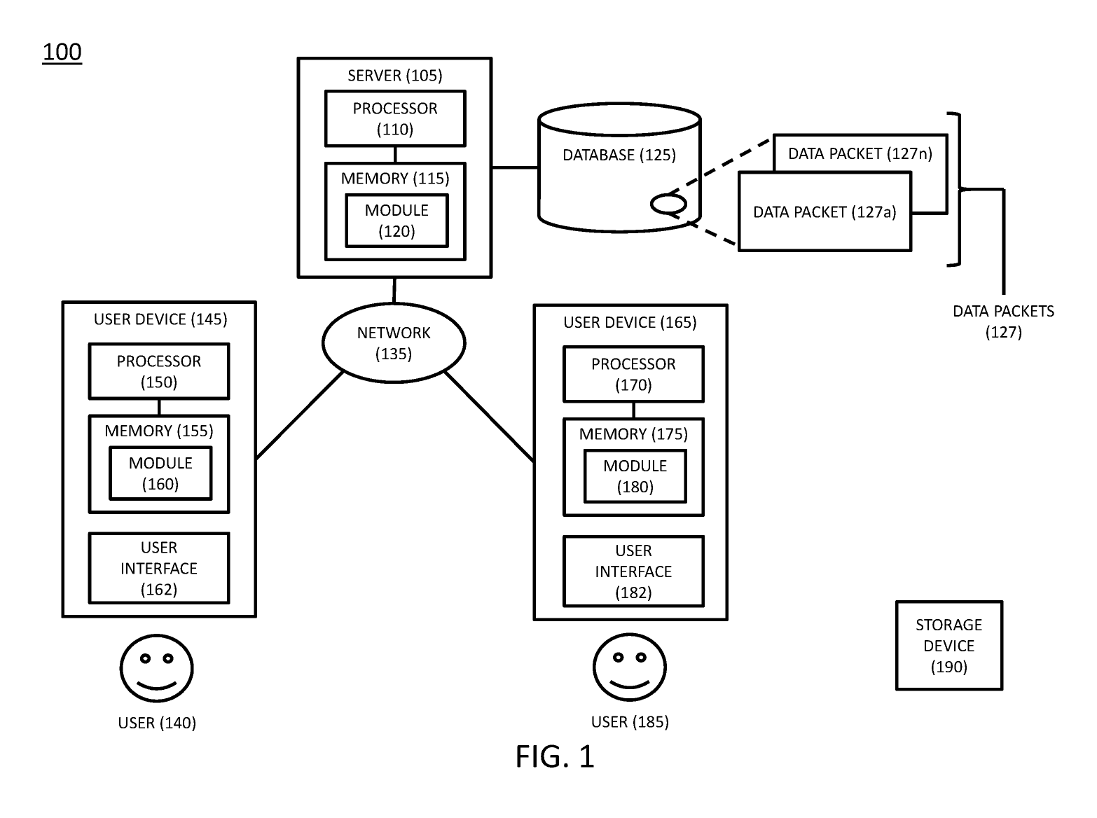

FIG. 1 is a block diagram of a data distribution system, i.e., system 100. System 100 includes a server 105, a database 125, a user device 145 and a user device 165. Server 105, user device 145 and user device 165 are communicatively coupled to a network 135. User devices 145 and 165 are examples of end-user systems.

Network 135 is a data communications network. Network 135 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (f) the Internet, or (g) a telephone network. Communications are conducted via network 135 by way of electronic signals and optical signals.

Server 105 includes a processor 110, and a memory 115 coupled to processor 110. Although server 105 is represented herein as a standalone device, it is not limited to such, but instead can be coupled to other devices (not shown) in a distributed processing system.

Processor 110 is an electronic device configured of logic circuitry that responds to and executes instructions.

Memory 115 is a tangible, non-transitory, computer-readable storage device encoded with a computer program. In this regard, memory 115 stores data and instructions, i.e., program code, that are readable and executable by processor 110 for controlling the operation of processor 110. One of the components of memory 115 is a module 120, i.e., a program module. Thus, module 120 contains instructions for controlling processor 110. Memory 115 may be implemented in a random access memory (RAM), a hard drive, a read only memory (ROM), or a combination thereof

The term “module” is used herein to denote a functional operation that may be embodied either as a stand-alone component or as an integrated configuration of a plurality of subordinate components. Thus, module 120 may be implemented as a single module or as a plurality of modules that operate in cooperation with one another. Moreover, although module 120 is described herein as being installed in memory 115, and therefore being implemented in software, it could be implemented in any of hardware (e.g., electronic circuitry), firmware, software, or a combination thereof

User device 145 is operated by a user 140, and includes a processor 150, a memory 155, and a user interface 162.

Processor 150 is an electronic device configured of logic circuitry that responds to and executes instructions.

Memory 155 is a tangible, non-transitory, computer-readable storage device encoded with a computer program. In this regard, memory 155 stores data and instructions, i.e., program code, that are readable and executable by processor 150 for controlling the operation of processor 150. One of the components of memory 155 is a module 160, i.e., a program module. Thus, module 160 contains instructions for controlling processor 150. Memory 155 may be implemented in a random access memory (RAM), a hard drive, a read only memory (ROM), or a combination thereof. Although module 160 is described herein as being installed in memory 155, and therefore being implemented in software, it could be implemented in any of hardware (e.g., electronic circuitry), firmware, software, or a combination thereof

User interface 162 includes an input device, such as a keyboard, speech recognition subsystem, or gesture recognition subsystem, for enabling user 140 to communicate information to and from processor 150, and via network 135, to and from server 105. User interface 162 also includes an output device such as a display or a speech synthesizer and a speaker. A cursor control or a touch-sensitive screen allows user 140 to utilize user interface 162 for communicating additional information and command selections to processor 150 and server 105.

User device 165 is operated by a user 185, and includes a processor 170, a memory 175, and a user interface 182. Memory 175, in turn, includes a module 180. User device 165, with regard to structure and operation, is similar to user device 145. Thus, processor 170, memory 175, module 180 and user interface 182, are structurally and operationally similar to processor 150, memory 155, module 160 and user interface 162.

Non-limiting examples of user devices 145 and 165 include desktop computers, laptop computers, smart phones, tablet computers, and other handheld computing devices.

While module 120 is indicated as being already loaded into memory 115, it may be configured on a storage device 190 for subsequent loading into memory 115. Storage device 190 is a tangible, non-transitory, computer-readable storage device that stores module 120 thereon. Examples of storage device 190 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random access memory, and (i) an electronic storage device coupled to server 105 via network 135. Modules 160 and 180 may also be configured on storage device 190 for subsequent loading into memories 155 and 175, respectively.

Database 125 contains a plurality of data packets, two of which are represented as data packets 127a and 127n, and collectively referred to as data packets 127. Users 140 and 185 wish to access one or more of data packets 127. System 100, and more specifically, processors 110, 150 and 170, in accordance with instructions in modules 120, 160 and 180, respectively, cooperate with one another to manage data access privileges, i.e., manage digital rights, for users 140 and 185, to data packets 127.

Although system 100 is shown as having two user devices, i.e., user devices 145 and 165, and one database, i.e., database 125, in practice system 100 may include any number of user devices and any number of databases. Also, although database 125 is shown as being directly coupled to server 105, database 125 may be remotely located from server 105, and coupled to server 105 via network 135.

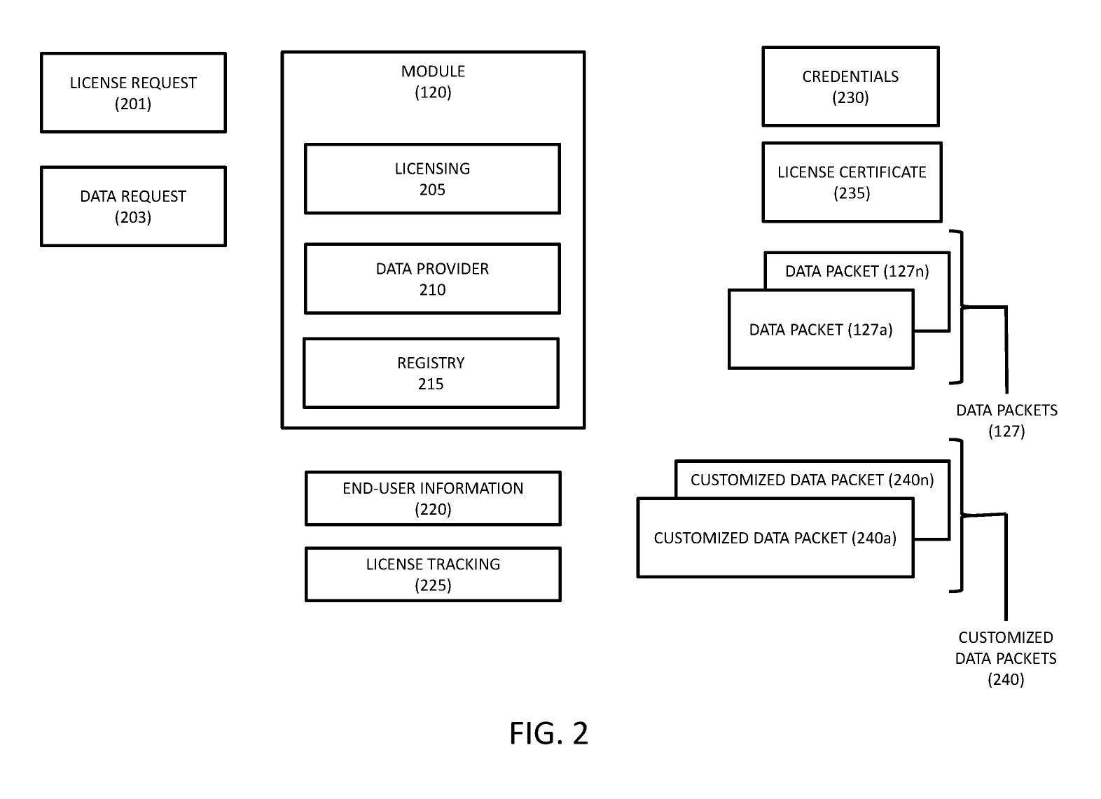

FIG. 2 is a block diagram that shows some details of module 120, and illustrates several items of information that are exchanged between server 105, user device 145 and user device 165. These items of information include a license request 201, a data request 203, credentials 230, a license certificate 235, and data packets 127. The items of information also include a plurality of customized data packets, two of which are represented as customized data packets 240a and 240n, and collectively referred to as customized data packets 240.

License request 201 will include a request for license certificate 235, which will enable a device to request and consume data packets 127. License request 201 will also contain information about the device, e.g., user device 145, and in some cases one or more additional devices, e.g., user device 165, that will need to be authorized to consume data packets 127. In this scenario, server 105 can issue license certificate 235 for either user device 145 and/or user device 165, for distinct or identical data packets 127. Data packets 127 will also contain information about terms of the license including reference to the specific license certificate 235 that was used to request and receive data packets 127 that enables/disables consumption of data packets 127 within each of user devices 145 and 165 based on the terms of the license certificate 235. This information is also tracked as part of license tracking 225 (described below). Having the terms of license in the packet of information enables a third party getting access to the packet of information to trace lineage of the packet of information by reaching out to the data provider. License request 201 precedes data request 203. Multiple data request 203 transactions can follow a single license request 201 transaction. License request 201 serves as a validation step for credentials 230 prior to issuing license certificate 235. Data request 203 includes license certificate 235 or a reference to license certificate 235 under which data request 203 is made. Data request 203 will also contain information about a type of data packet 127 that is being requested. Examples of information about type of data packet include use-cases (credit decision), system specific (CRM), user-persona (sales person).

Customized data packets 240a-240n are customized, i.e., modified, versions of data packets 127a-127n, respectively. For example, server 105 may modify data packet 127a to produce data packet 240a in accordance with one or more of (a) a characteristic of user device 165, (b) an identity of user 185, or (c) an application, e.g., an ERP application, that is being utilized by user device 165.

Module 120 includes three processing modules, namely licensing 205, data provider 210, and registry 215.

Licensing 205 issues license certificate 235 based on license requests 201 received from user devices 145 and 165. Data provider 210 creates and configures a data packet 127 based on the terms of license certificate 235 that a requesting user device 145 or 165 sends as part of a data request 203.

Registry 215 maintains end-user information 220 and license tracking 225. End-user information 220 includes identifying attributes (e.g., name, company, and associated devices). Registry 215 updates and tracks changes related to end-user information 220 as well as license certificate(s) 235 that are issued for each user device 145/165.

License tracking 225 includes the utilization of the license certificate 235, over time, from each user device 145/165. License tracking 225 will also capture a scenario where license certificate 235 was issued for user device 145 with permissions to transfer license certificate 235 to other devices (e.g., user device 165), license certificate 235 was transferred to user device 165, and user device 165 initiated a new data request 203 using license certificate 235. License tracking 225 enables tracking of license certificate 235. Licensing tracking 225 tracks all license certificates, e.g., license certificate 235, issued and all data packets 127 authorized for consumption across multiple devices, e.g., user devices 145 and 165. This includes customizations of data packets 127 for different users and different user devices.

Thus, registry 215 maintains information about users 140 and 185, who have system-specific entitlement to data packets 127. End-user information 220 and license tracking 225 reside in memory 115.

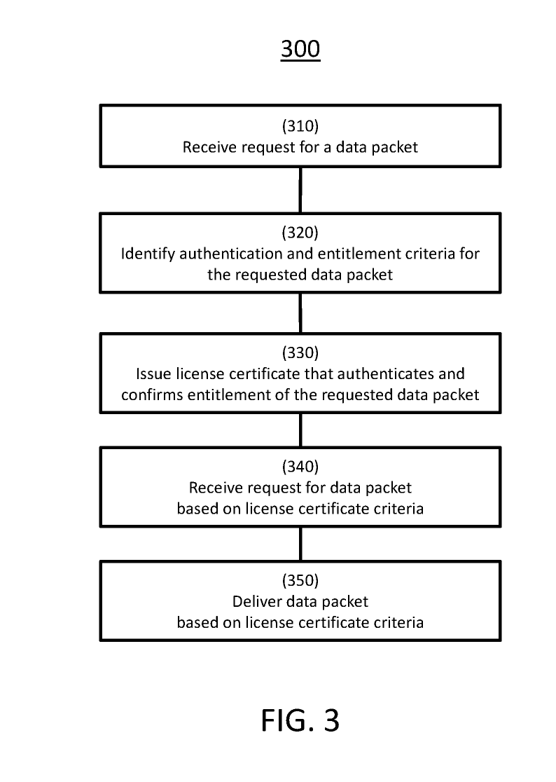

FIG. 3 is a flowchart of a method 300 that is performed by server 105, and more specifically, processor 110, in accordance with instructions in module 120. Server 105 receives license request 201 followed by data request 203. In some cases, the requesting device, e.g., user device 145, might have a license certificate 235 previously issued and can use this license certificate 235 to request a data packet 127 using a data request 203.

Assume that user 140 desires access to data packet 127a. Accordingly, user device 145 transmits license request 201 to server 105. License request 201 contains information about user 140, user device 145 and one or more data packets 127 requested, terms of use such as time, single/multi use, and ability to transfer license certificate 235 to another end-user, e.g., user 185. Once user device 145 has received license certificate 235, this license certificate 235 can be used as part of a data request 203. This data request 203 should contain details of the data packet(s) 127 requested, and includes a license certificate 235.

In operation 310, processor 110 receives license request 201 and data request 203 from user device 145.

In operation 320, processor 110 identifies authentication and entitlement criteria for a data packet, e.g., data packet 127a. Licensing 205, registry 215 and data provider 210 work in coordination to respond to a request for a data packet. Licensing 205 evaluates the request from user device 145, and authenticates credentials 230 from registry 215, which houses information about customers, devices and types of data packets that customers are entitled to consume.

In operation 330, processor 110 issues and transmits, to user device 145, licensing certificate 235, which authenticates and confirms entitlement of data packet 127a. Processor 110 utilizes or updates end-user information 220, license tracking 225 and credentials 230. License certificate 235 provides for user device 145 to retrieve or gain access to data packet 127a. License certificate 235 is only issued to an authorized end-user, e.g., user 140. Information contained in license certificate 235 includes terms, duration and types of content, and user device(s) for which this certificate is enabled, as well as notification on ability to assign or share the certificate with a different end-user under a set of defined terms. User device 145 is now in possession of a license certificate 235 for a specific type of data packet 127a.

In operation 340, user device 145 transmits, and processor 110 receives, data request 203, based on license certificate 235 criteria. Thus, data request 203 contains a license certificate 235 for a specific type of data packet 127a based on validated credentials.

In operation 350, processor 110 delivers, to user device 145, a customized data packet 240a based on license certificate 235 criteria. It is possible that the request 203 and certificate 235 might be to return data packet 127a without any customization or modifications. In that case, data provider 210 will return data packet 127a, unaltered, to user device 145. In a scenario where the request 203 and certificate 235 are for a modified or customized version of the data packet 127a, processor 110 executes procedures in licensing 205, data provider 210 and registry 215 to (a) obtain data packet 127a from database 125, (b) format or edit data in data packet 127a as defined and allowed in license certificate 235, thus yielding customized data packet 240a, i.e., a customized version of data packet 127a, and (c) transmit customized data packet 240a to user device 145.

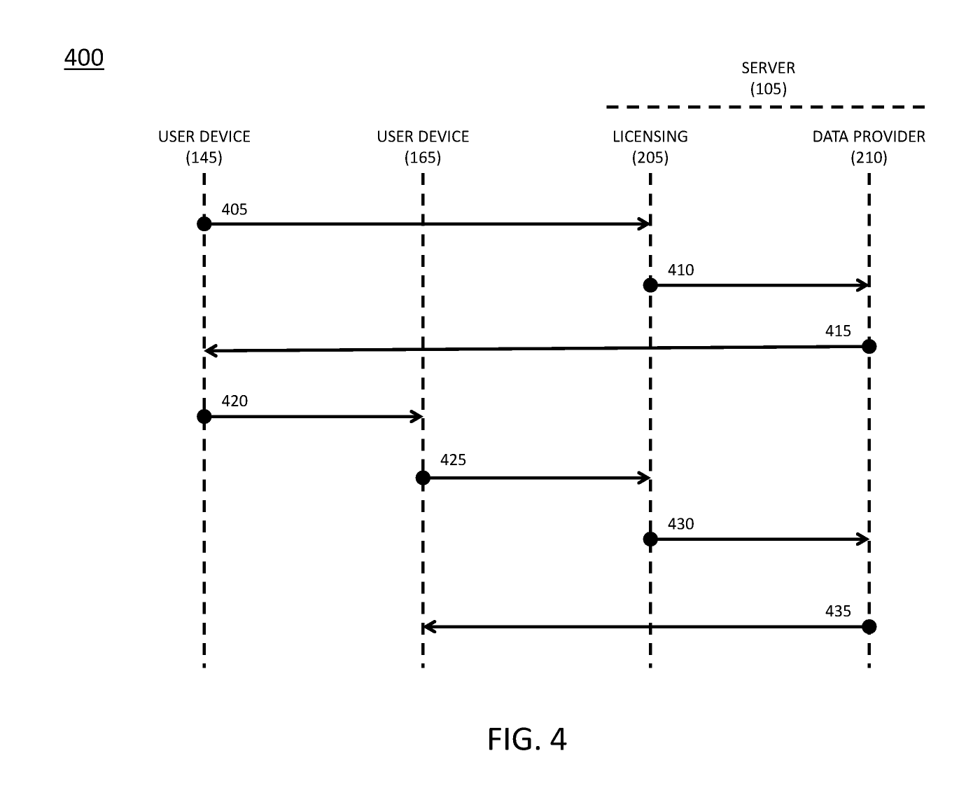

FIG. 4 is a signal flow diagram of a sequence of communications taking place during a communication session 400, involving user device 145, user device 165 and server 105. In brief, in communication session 400, (a) user device 145 obtains license certificate 235 and passes it to user device 165, and (b) user device 165 uses license certificate 235 to access data packet 127a.

In server 105, as mentioned above, operations are performed by processor 110. In communication session 400, some operations are performed by processor 110 in accordance with licensing 205 and some operations are performed by processor 110 in accordance with data provider 210. In FIG. 4, in order to explain the operations, each of licensing 205 and data provider 210 is represented as a participant in communication session 400, even though the operations are actually being performed by processor 110.

In operation 405, user device 145 transmits, and licensing 205 receives a data request 203 using an existing license certificate 235 or a license request 201. Once licensing 205 receives and issues a license certificate 235, user device 145 can then execute a data request 203 using this license certificate 235. There are at least two possible scenarios, namely, (1) requesting a license certificate 235 first, and using that license certificate 235 to request data, and (2) using a previously obtained license certificate 235 to request data.

In operation 410, licensing 205 evaluates data request 203 to determine whether user device 145 is authorized to consume data packet 127a. If user device 145 is authorized to consume data packet 127a, licensing 205 issues a license certificate 235 for data packet 127a that can be used by user device 145. Thereafter, licensing 205 sends, to data provider 210, a license certificate 235 that specifically allows for user device 145 to be able to consume data packet 127a. For each subsequent request for data, as part of operation 410, licensing 205 will validate the prior license certificate 235 and pass this validated license certificate 235 to data provider 210.

Data provider 210 thus receives a license certificate 235 from licensing 205 indicating that user device 145 has requested data packet 127a and is authorized to receive data packet 127a. Information about the authentication and validation is contained within license certificate 235.

In operation 415, data provider 210 transmits license certificate 235 to user device 145. For all subsequent requests from user device 145, user device 145 will initiate the request with license certificate 235 as part of the request. In a subsequent communication session 400, when data provider 210 considers a subsequent request from user device 145 for data packet 127a, where the request includes license certificate 235, data provider 210 will fulfill the request with data packet 127a as part of operation 415 in the subsequent communication session 400.

License certificate 235 can be a transferable or non-transferable certificate. Additionally it might be for a right to consume data packet 127a in both user devices 145 and 165, or it might be for a right to consume a different data packet, e.g., a data packet 127b (not shown) or a modified/customized data packet 240a. Assume that license certificate 235 is transferable.

In operation 420, user device 145 sends license certificate 235 to user device 165.

In operation 425, user device 165 transmits license certificate 235 to licensing 205. Thus, licensing 205 receives a data request and a license certificate 235 that was originally created for user device 145 with permissions to re-assign to user device 165.

In operation 430, licensing 205 validates license certificate 235 in a manner similar to that described above for operation 410. If user device 165 is authorized to consume data packet 127a, licensing 205 issues a license certificate 235, i.e., an updated license certificate 235, for data packet 127a that can be used by user device 165. The updated license certificate 235 might have terms unique or specific to user device 165. As an example, user device 165 might not be authorized to share or transfer the updated license certificate 235 to additional end-user devices. Thereafter, licensing 205 sends, to data provider 210, the updated license certificate 235, which provides privileges for user device 165 to consume data packet 127a.

In operation 435, data provider 210 transmits data packet 127a to user device 165.

An example of a practical application of system 100 is in a case where user 140 is a parent, user 185 is a child, and data packets 127 are of a video that includes sexually explicit material. A request from a user device can include a descriptor of an identity of a user of the device, and server 105 will prepare data packets 127 in accordance with the identity of the user. Server 105 will send user 140, i.e., the parent, an uncensored version of data packets 127, but send user 185, i.e., the child, a censored version of data packets 127. That is, if user 185 requests the video, server 105 will edit data packets 127, thus yielding customized data packets 240 that are censored for viewing by user 185.

Other practical applications of system 100 include situations where data packets 127 contain audio recordings, medical records, financial information, or documents that need to be redacted. Thus, a particular user will receive only the data to which the user is entitled, i.e., for which the user has privileges.

A request from a user device can include a descriptor of an identity of the user device, e.g., a serial number of the device, and server 105 can then prepare customized data packets 240 in accordance with the identity of the user device. Thus, each of user device 145 and user device 165 will receive only the data for which it is licensed.

A request from a user device can include a descriptor of an identity of a characteristic of the user device, and server 105 can then prepare customized data packets 240 in accordance with the characteristic. For example, if data packets 127 are of a video in high-definition (HD) format, and user device 165 is not HD-compatible but can accommodate a video in a standard format, server 105 will convert the video from HD format to standard format.

A request from a user device can include a descriptor of an application being utilized by a user device, and server 105 can then prepare customized data packets 240 in accordance with the application. For example, user device 145 may be running a CRM application, and user device 165 may be running an ERP application. For user device 145, server 105 will prepare customized data packets 240 in accordance with the CRM application, and for user device 165, server 105 will prepare customized data packets 240 in accordance with the ERP application. Thus, each of user device 145 and user device 165 will receive only the data that it needs for its respective application. Similarly, each of user device 145 and user device 165 will receive only the data for which its respective application is licensed.

The benefits of system 100 are twofold. First, it enables the use-case-specific or application-specific consumption of data in in an automated manner. Systems such as CRM and ERP that use data provided via system 100 will not need to move and store more data than they need. This translates into efficiency gains in storage and bandwidth and also helps reduce the need for manual intervention to manage access privileges, e.g., remove certain data sets from systems that are not licensed to access them. Additionally, data access privileges are enabled in an automated manner similar to a computer and a printer being able to communicate with each other and access the required and allowed information from each other when connected. Second, the ability to track the same information, e.g., a company billing record, as it flows from a CRM system to an ERP system to a payment system with different packets of use-case-specific data getting accessed, attached and used in each of these systems enables the easier implementation of multiple use licensing models for data.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
transmitting to a first user device, a license to access data in a database;
receiving said license from a second user device;
customizing said data, thus yielding customized data; and
transmitting said customized data to said second user device.

2. The method of claim 1, wherein said customizing includes modifying said data.

3. The method of claim 1, further comprising, prior to said customizing, receiving a descriptor of an identity of a user of said second user device,
wherein said customizing includes configuring said customized data in accordance with said identity.

4. The method of claim 1, further comprising, prior to said customizing, receiving a descriptor of an identity of said second user device,
wherein said customizing includes configuring said customized data in accordance with said identity.

5. The method of claim 1, further comprising, prior to said customizing, receiving a descriptor of a characteristic of said second user device,
wherein said customizing includes configuring said customized data in accordance with said characteristic.

6. The method of claim 1, further comprising, prior to said customizing, receiving a descriptor of an application that is being utilized by said second user device,
wherein said customizing includes configuring said customized data in accordance with said application.

7. A system comprising:
a processor; and
a memory that includes instructions that are readable by said processor to cause said processor to perform operations of:
transmitting to a first user device, a license to access data in a database;
receiving said license from a second user device;
customizing said data, thus yielding customized data; and
transmitting said customized data to said second user device.

8. The system of claim 7, wherein said customizing includes modifying said data.

9. The system of claim 7,
wherein said instructions also cause said processor to perform, prior to said customizing, an operation of receiving a descriptor of an identity of a user of said second user device, and
wherein said customizing includes configuring said customized data in accordance with said identity.

10. The system of claim 7,
wherein said instructions also cause said processor to perform, prior to said customizing, an operation of receiving a descriptor of an identity of said second user device, and
wherein said customizing includes configuring said customized data in accordance with said identity.

11. The system of claim 7,
wherein said instructions also cause said processor to perform, prior to said customizing, an operation of receiving a descriptor of a characteristic of said second user device, and
wherein said customizing includes configuring said customized data in accordance with said characteristic.

12. The system of claim 7,
wherein said instructions also cause said processor to perform, prior to said customizing, an operation of receiving a descriptor of an application that is being utilized by said second user device, and
wherein said customizing includes configuring said customized data in accordance with said application.

13. A storage device comprising instructions that are readable by a processor to cause said processor to perform operations of:
transmitting to a first user device, a license to access data in a database;
receiving said license from a second user device;
customizing said data, thus yielding customized data; and
transmitting said customized data to said second user device.

14. The storage device of claim 13, wherein said customizing includes modifying said data.

15. The storage device of claim 13,
wherein said instructions also cause said processor to perform, prior to said customizing, an operation of receiving a descriptor of an identity of a user of said second user device, and
wherein said customizing includes configuring said customized data in accordance with said identity.

16. The storage device of claim 13,
wherein said instructions also cause said processor to perform, prior to said customizing, an operation of receiving a descriptor of an identity of said second user device, and
wherein said customizing includes configuring said customized data in accordance with said identity.

17. The storage device of claim 13,
wherein said instructions also cause said processor to perform, prior to said customizing, an operation of receiving a descriptor of a characteristic of said second user device, and
wherein said customizing includes configuring said customized data in accordance with said characteristic.

18. The storage device of claim 13,
wherein said instructions also cause said processor to perform, prior to said customizing, an operation of receiving a descriptor of an application that is being utilized by said second user device, and
wherein said customizing includes configuring said customized data in accordance with said application.
